(19) United States
(12) Patent Application Publication
(10) Pub. No.: US 2026/0086775 A1
(43) Pub. Date: Mar. 26, 2026

(54) CUSTOMIZED APPLICATION CODE GENERATION AND EXTENSIBILITY SYSTEM LEVERAGING LLM CAPABILITIES

(71) Applicant: SAP SE, Walldorf (DE)

(72) Inventors: Wendeng LI, Shanghai (CN); Fei HE, Shanghai (CN); Hua WANG, Shanghai (CN); Yixin WANG, Shanghai (CN); Yawen DU, Shanghai (CN); Fang SUI, Shanghai (CN)

(21) Appl. No.: 18/894,141

(22) Filed: Sep. 24, 2024

(51) Int. Cl. G06F 8/34; G06F 8/65

(52) U.S. Cl. CPC G06F 8/34; G06F 8/65

(57) ABSTRACT

System, method, and various embodiments for an extensibility and code generation system leveraging LLM capabilities, are described herein. An embodiment operates by receiving, via a user interface, a command to update an application. Metadata of the application, including one or more data elements associated with the update are retrieved and displayed via the user interface. New code corresponding to the update is generated and provided for display. The new code, corresponding to the update, is integrated into the application and made available to one or more users.

### BACKGROUND

The ability to modify or update an application is an important part of increasing the utility and usability of the application. However, performing these application updates or changes is a highly technical process that is unavailable to the end users of the application. However, this becomes problematic because it is these end users who are more familiar with what changes would improve the actual functionality or utility of the application, relative to a developer.

These changes must first wait until a developer is available, thus causing the application to continue to operate in a sub-optimal manner. Further, even a simple change to the application may require multiple back-and-forth interactions between the developer and the user, and multiple versions of the application may need to be created, compiled, and tested, before the end user actually gets the update they need or requested.

### BRIEF DESCRIPTION OF THE DRAWINGS

The accompanying drawings are incorporated herein and form a part of the specification.

FIG. 1 is a block diagram illustrating example functionality for a code generation and extensibility system (CGS), according to some embodiments.

FIG. 2 illustrates an example user interface for a code generation and extensibility system (CGS), according to some embodiments.

FIG. 3 is a flowchart illustrating example operations for providing a code generation and extensibility system (CGS), according to some embodiments.

FIG. 4 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a customized application extensibility and code generation system leveraging large language model (LLM) capabilities.

The ability to modify or update an application is an important part of increasing the utility and usability of the application. However, performing these application updates or changes is a highly technical process that is unavailable to the end users of the application. However, this becomes problematic because it is these end users who are more familiar with what changes would improve the actual functionality or utility of the application, relative to a developer.

These changes must first wait until a developer is available, thus causing the application to continue to operate in a sub-optimal manner. Further, even a simple change to the application may require multiple back-and-forth interactions between the developer and the user, and multiple versions of the application may need to be created, compiled, and tested, before the end user actually gets the update they need or requested.

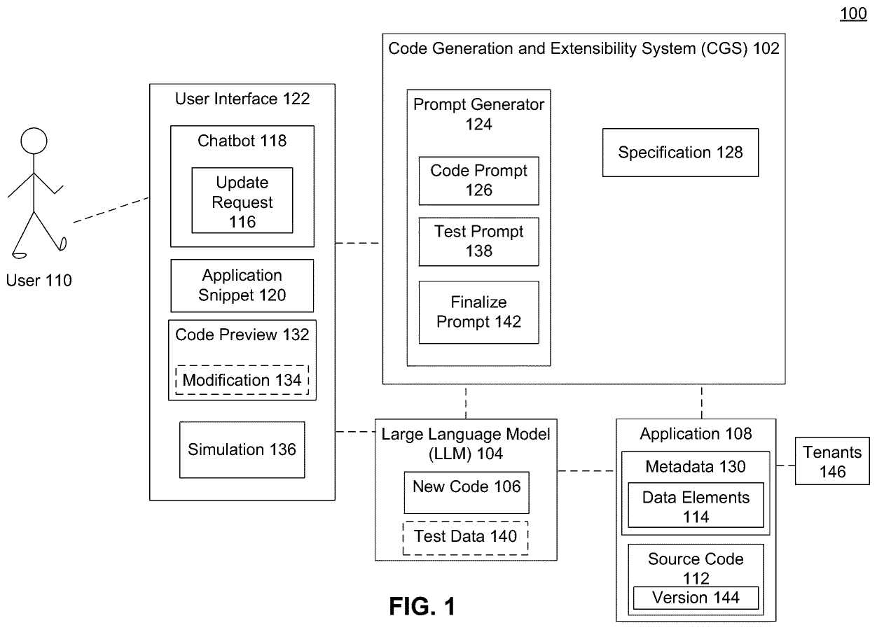

FIG. 1 is a block diagram 100 illustrating example functionality for a code generation and extensibility system (CGS) 102, according to some embodiments. CGS 102 may leverage the processing capabilities of a large language model (LLM) 104 to allow a non-technical user 110 to perform updates to an application 108, which may involve generating new code 106. CGS 102 may allow the user 110 to perform such updates without requiring the user 110 to perform any coding themselves or waiting for a developer to perform the coding updates in a resource consuming back-and-forth process. Instead, CGS 102 may allow the user 110 to leverage the coding capabilities of an LLM 104 to perform the code changes, and allow the user 110 to test the updated code, and deploy the update to the application 108.

CGS 102 provides significant computational advantages over traditional code development processes which requiring back-and-forth communications between different users and multiple versions of code updates which would need to be manually performed, compiled, and tested. CGS 102 streamlines this process, and enables the user 110 to user plain language (e.g., non-programming language) instructions to cause CGS 102 perform the requested updates to an application 108.

In some embodiments, the user 110 may submit an update request 116 via a chatbot 118 (or chatbot interface). The update request 116 may include a plain language, non-computing language or non-programming language, instructions indicating what change or update(s) the user 110 desires for application 108. CGS 102 allows the user 110 to submit an update request 116 using spoken language or text, without any knowledge of programming, to change the functionality of an application 108.

Application 108 may include any computer program, application, web application, or app, that includes source code 112 that can be updated to modify the functionality of application 108. Source code 112 may include any computing code written across one or more computing or programming languages which is used to execute application 108 (which may be done after compiling the source code 112). In some embodiments, source code 112 may be stored or executed across multiple files or computing devices. In some embodiments, application 108 may include an application operating in a cloud or other network-based environment, which may be accessible to one or more users.

In some embodiments, user 110 may be a non-technical or end user of application 108, who may not be familiar with how to write code or update source code 112. In some embodiments, user 110 may want to update some functionality in application 108. For example, user 110 may want to add, remove, or update existing data elements 114 of application 108. A data element 114 may include any data or functional feature of application 108. Example data elements 114 may include, but are not limited to, user interface elements (including size, positioning, color), data fields, and or processing commands (e.g., how various calculations are performed, etc.). In some embodiments, data elements 114 may be part of metadata 130. Metadata 130 may include information about data, such as data element names, data definitions, data format, data metrics, data creation information, data size, data assumptions, data relationships, data calibration, etc.

However, without knowing how to modify source code 112, user 110 may not be able to update the application 108. Instead, a user would have to wait for a developer to perform an update of the application, and hope the developer updated in the application in the manner desired by the user. If the developer misunderstands the user or does not properly perform the update, there may be multiple back and forth developer, compilation, and testing sessions, wasting valuable time and computing resources.

CGS 102 allows for a non-technical user 110 to update application 108, without any prior knowledge of programming or how to update source code 112. In some embodiments, user 110 may not be authorized to directly access or update source code 112. CGS 102 may allow a user 110 to directly communicate an update request 116 to CGS 102 using plain language or natural language to a chatbot 118. CGS 102, which may include chatbot 118, may interpret or translate the update request 116 into one more technical commands and perform all the technical operations required to update application 108 in accordance with the update request 116. CGS 102 obviates the need for a developer or even development background by the user 110 to update the source code 112 of application 108.

As noted above, in some embodiments, CGS 102 may provide a chatbot 118 that interacts with user 110. Chatbot 118 may include a computer program that is designed to simulate a conversation with a human user. Chatbot 118 may include any interface that enables a user to access chatbot functionality or interact with a chatbot. In some embodiments, chatbot 118 may be accessible via the internet (e.g., through a website), a messaging application (including textual and/or audio communications), or any add on messaging service that enables two-way communications. Chatbot 118 may allow a user 110 to speak and/or type input, such as update request 116 using natural or plain language. Chatbot 118 may provide a response in audio, text, or multimedia format, including hyperlinks.

In some embodiments, chatbot 118 may be trained to respond to particular user inputs, based on identifying particular keywords. In some embodiments, chatbot 118 may perform initial NLP (natural language processing) on the instructions provided by user 110 via update request 116 (or other user input).

For example, update request 116 may be “Add a new field: Address, to the application”. Chatbot 118 may interpret this update request 116 to correspond to an add a new field command for ‘address’ data. In some embodiments, chatbot 118 may ask the user 10 for additional information if update request 116 is ambiguous or missing information. For example, adding a new field may require both a field name and a data type for the field. If the data type was missing (e.g., String), then chatbot 118 may prompt user for a required data type for the data field ‘address’.

In some embodiments, chatbot 118 may confirm the interpretation or understanding of update request 116. In continuing the example above, chatbot 118 may output: “You want to add the Address field to the application, is that correct?” And wait for the user 110 to respond affirmatively, or provide a new or updated instruction or update request 116.

In some embodiments, CGS 102 may generate an application snippet 120 in response to update request 116. Application snippet 120 may include a visual depiction of a portion of application 108, as may be related to update request 116. For example, if update request 116 is directed to a particular visual interface of application, the application snippet 120 may include a screenshot of the interface (prior to any such update). Or, for example, if update request 116 is directed to updating a particular data field, the application snippet 120 may include a list of existing data fields in the application 108 with any additional or relevant information (e.g., such as to which functionality each field is related, etc.). In some embodiments, application snippet 120 may include a copy or visual depiction of metadata 130 and/or source code 112.

CGS 102 may generate a visual depiction of application snippet 120, and display the application snippet 120 in a user interface 122 for user 110. In some embodiments, with application snippet 120 visible in user interface 122, CGS 102 may ask user 110 to confirm their update request 116. For example, the user 110 may be able to see the list of existing data fields of application 108 in application snippet 120, and may be asked to confirm their update request 116 to modify, add, or delete a data field. The user 110 may also be provided the opportunity to change or discard their update request 116, and/or submit a new update request 116. The application snippet 120 may provide the user 110 with additional context from application 108 related to their update request 116.

In some embodiments, update request 116 may include a request for an application snippet 120, which may be received prior to any update instructions. For example, user 110 may request to see a list of existing data fields from application 108, and then submit an update request 116 related to modifying or deleting an existing data field, or adding a new data field.

Upon receiving update request 116, or a confirmation of the request 116, a prompt generator 124 may generate one or more prompts for LLM 104 to perform some functionality or generate a response. A prompt may include one or more lines of text organized across one or more documents that is particularly formatted to by understandable by a large language model (LLM) 104. LLM 104 may include an artificial intelligence, machine learning, or deep learning model that is configured to execute data processing commands from plain-text (e.g., not requiring computer language or coded input). LLM 104 may include any computing system that is configured to perform processing tasks based on text-based or plain language inputs. LLM 104 may be configured to create original content from one or more documents or input in accordance with a prompt. In some embodiments, LLM 104 may include a generative pre-training transformer (GPT).

In some embodiments, LLM 104 may be specifically trained on a specification 128. Specification 128 may include a set of guidelines that were used to generate or code application 108, and may include references to metadata 130 of application 108. Specification 128 may include a template, library, or set of rules or configurations used to generate one or more applications 108. For example, even though only a single application 108 is illustrated, in some embodiments, there may be a suite of applications which are all developed in accordance with specification 128. Specification 128 may include a naming convention, library locations, etc. LLM 104 may be specifically trained with specification 128, such that LLM 104 is able to understand application 108 through metadata 130 and generate new code 106 in accordance with specification 128 for application 108, that can be integrated into source code 112, written in the same programing language as source code 112, or a compatible programming language.

Example prompts which may be generated by prompt generator 124 include a code prompt 126, test prompt 138, and finalize prompt 142. In other embodiments, different or additional prompts may be generated. For example, a prompt to generate application snippet 120 may be generated by prompt generator 124.

Code prompt 126 may be a prompt generated to request new code 106 from LLM 104, corresponding to update request 116. In some embodiments, prompt generator 124 may provide the update request 116 and/or the name of the application 108 as input for the code prompt 126, and request new code 106 as output from the LLM 104. The new code 106 may include any revisions to be added to source code 112. In some embodiments, the new code 106 may include deleting or modifying existing source code 112.

In some embodiments, LLM 104 may receive or generate a copy (of at least a portion) of source code 112, and the new code 106 may be generated and integrated into the copy of source code 112. Copying the source code 112 (to another location or computing device local to user 110) may avoid potential issues that would otherwise arise from directly modifying source code 112 of application 108.

CGS 102 may receive the new code 106 from LLM 104, and provide the new code 106 in a code preview 132 window in user interface 122. The code preview 132 may include the new code 106 that has been generated in accordance with update request 116. In some embodiments, code preview 132 may include the original (or copy) of source code 112 in a first color, and the new code 106 (including any modifications or deletions to source code 112) in a second, different color. In some embodiments, the code preview 132 may be displayed simultaneously with the application snippet 120. In some embodiments, code preview 132 may be displayed within chatbot interface 118.

In some embodiments, user 110 may approve the code preview 132 or submit a modification 134. Modification 134 may include any user submitted change to the new code 106 as provided in code preview 132. Modification 134 may include adding additional code and/or removing or modifying the new code 106. In some embodiments, modification 134 may include a request to roll back a deletion of source code 112, as done as part of new code 106. In some embodiments, user 110 my request to bypass the code preview 132 altogether.

Upon receiving approval of new code 106, or a modification 134, CGS 102 may generate a simulation 136. Or, for example, if user 110 opts to bypass code preview 132, the new code 106 may be directly integrated into a local copy of source code 112 as part of generating a simulation 136. Simulation 136 may include a local execution of application 108 with the new code 106 (and any approved modification 134) for user 110 to interact with or play with. Simulation 136 may include a compilation and execution of a local copy of source code 112 with new code 106, but may not impact or change the original source code 112 or application 108.

As part of generating simulation, in some embodiments, prompt generator 124 may generate a test prompt 138. Test prompt 138 may be a request for LLM 104 to generate a set of test data 140 that may be used to test the data elements 114 impacted by new code 106. In some embodiments, test data 140 may not be required, depending on the nature of the update request 116.

In some embodiments, test data 140 may be provided to user 110 as part of simulation 136. Thus, as part of simulation 136, a user 110 may see the input test data 140 and an output generated with the test data 140 by an updated version of the application (with the new code 106). In some embodiments, simulation 136 may include an original version of application 108 (before new code 106) and a new version of application 108 (with new code 106) both executing with or without test data 140, so that user may see the differences. Simulation 136 may allow user 110 to play with and test the new code 106. In some embodiments, simulation 136 may access to the entire execution of application 108 with new code 106. In some embodiments, user 110 may reject or approve the simulation 136. In some embodiments, user 110 may provide a subsequent update request 116 to update the newest (local) version of application 108 (with new code 106) to further modify the new code 106 and/or local source code.

In some embodiments, simulation 136 may include a local update to a copy of the source code 112, accessible only to user 110. For example, as noted above, application 108 may be a network-accessible or cloud-based application 108. Rather than update the cloud-version or live version of the application 108, CGS 102 may update a local copy or local version of the application 108 only for user 110. The updated local version may include the new code 106, and any modification 134, generated in accordance with update request 116. The user 110 may then have the option to either reject or accept the simulation 136.

If user 110 rejects simulation 136, then CGS 102 may discard the local version of application 108 (e.g., including the new code 106), and source code 112 of the production version of application 108 may remain unchanged. If user approves simulation 136, then CGS 102 may integrate the new code 106 into source code 112. In some embodiments, the user 110 may schedule the update for a specific date/time in the future.

In some embodiments, prompt generator 124 may generate a finalize prompt 142. Finalize prompt 142 may include instructions to LLM 104 to deploy the update by updating source code 112 in accordance with new code 106. In some embodiments, LLM 104 may replace source code 112 with the local copy of source code 112 that was tested and already includes new code 106. When the update is completed, LLM 104 may provide a notification to CGS 102, which may then be communicated to user 110 through user interface 122, chatbot 118, or other electronic messaging (e.g., text message, phone call, email, etc.).

In some embodiments, CGS 102 may maintain different versions 144 of source code 112 (or application 108). For example, user 110 may only be authorized to update a first version 144 of application 108 which the user 110 is accessing, such that the new code 106 or update corresponding to update request 116 is not visible to any other users of application 108. However, there may be multiple additional versions 144 of application 108 which are accessible to other users, which are unaffected by the deployment of new code 106 to the first version 144 of application 108.

In some embodiments, CGS 102 may maintain a list of tenants 146 who are accessing a particular version 144 of application 108. Tenants 146 may include any number of end users who are accessing a particular version 144 of application 108. For example, user 110 may be the manager for or member of a division within an organization with six employees. Even though the application 108 may be used by all one hundred members of the organization, the update of new code 106, as made by user, may only be accessible by the six members of the same team or division, each of whom may be a tenant 146 of the same version 144.

In some embodiments, with proper authorization, the user 110 may submit a subsequent update request 116 for CGS 102 to update all the versions 144 of application 108 for all tenants 146. This may include prompt generator 124 generating a new finalize prompt 142, asking LLM 104 to propagate the new code 106 to all the versions 144 of application 108 (e.g. that user 110 is authorized to update). In some embodiments, the test phase and simulation 136 may be skipped in these subsequent updates since the new code 106 has already been tested and integrated into an existing version 144 of application 108. In some embodiments, the finalize prompt 142 may indicate which version(s) 144 of application 108 is to be updated with the new code 106.

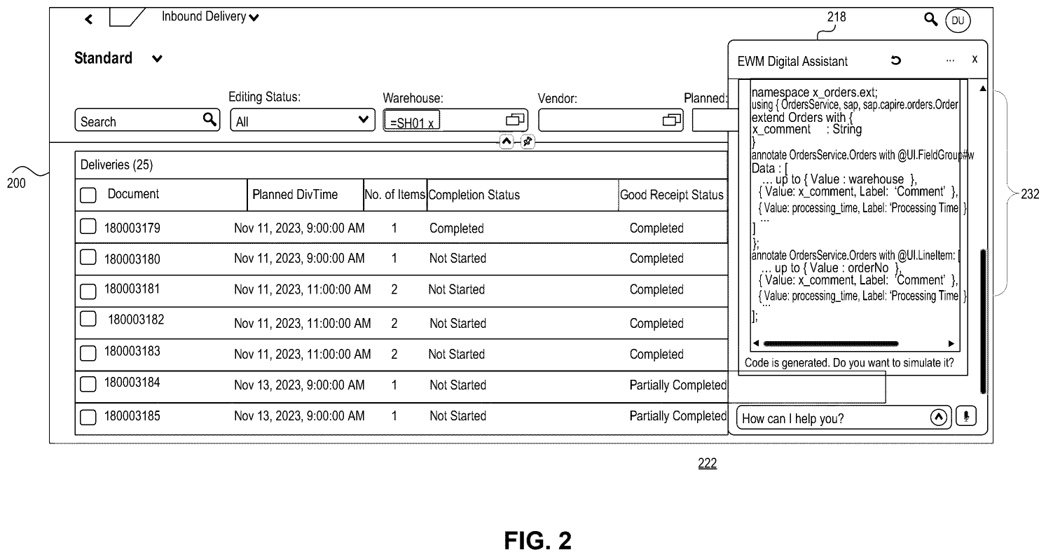

FIG. 2 illustrates an example user interface 222 for a code generation and extensibility system (CGS) 102, according to some embodiments. The user interface 222 may include an application snippet 220 (corresponding to an example of application snippet 120), and a chatbot window 218 (corresponding to an example of chatbot 118).

In the example illustrated, the update request 116, as provided in chatbot window 218 by a user 110, may have been a request to add a new data field to an application 108. In response to the update request 116, CGS 102 may have generated or captured application snippet 220 illustrating the existing data fields of application 108. In some embodiments, application snippet 120 may include one or more screen captures of a user interface of application 108, source code 112, and/or metadata 130. The list of data fields in application snippet 120 may be retrieved by CGS 102 from metadata 130.

In some embodiments, upon displaying the application snippet 220 including the existing data fields of application 108, chatbot 118 may ask user to confirm their instruction to add a new data field.

Upon receiving confirmation, CGS 102 may generate a code prompt 126 and receive new code 106 from an LLM 104, trained to generate code for application 108 in accordance with specification 128. As illustrated in section 232, CGS 102 may provide the new code 106 to the user 110 to review/confirm. In some embodiments, the new code 106 may include some portions or copies of the pre-existing source code 112.

In some embodiments, the user 110 may update the new code 106 illustrated in section 232. For example, user 110 may submit a request to update the new code 106. Responsive to this request, CGS 102 may generate a new editable code window (not illustrated), where user can update or modify new code 106 (e.g., by submitting a modification 134). Then, when the user approves the new code 106, with or without a user modification 134, CGS 102 may compile the new code and generate a simulation 136 for user to test and approve. As described above, CGS 102 may also generate test data 140, if applicable.

In some embodiments, CGS 102 may generate the simulation 136 prior to providing the code preview 132. For example, user 110 may play with simulation 136 and may approve simulation without approving new code 106. Or, for example, the user may specifically request to review or modify the new code 106 after playing with the simulation 136. Upon receiving a final approval from user 110 of the new code 106 and/or simulation 136, CGS 102 may generate the finalize prompt 142 causing LLM 104 to update source code 112 for the appropriate version(s) 144 of application 108, making it available to any tenants 145 of that version 144.

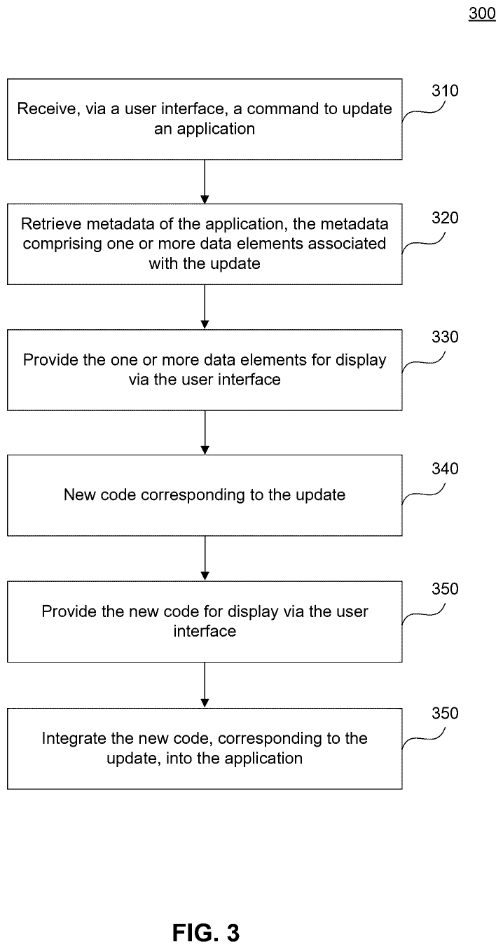

FIG. 3 is a flowchart 300 illustrating example operations for providing a code generation and extensibility system (CGS) 102, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1.

In 310, a command to update an application is received via a user interface. For example, for example, chatbot 118 may receive an update request 116 from a user 110. The update request 116 may include a plain language (e.g., non-programming language) request by a user 110 to modify an application 108 in some way. In some embodiments, the update request 116 may indicate one or more screens or user interfaces of application 108 and produce a visible change from an end user point of view.

In 320, metadata of the application is retrieved, the metadata comprising one or more data elements associated with the update. For example, CGS 102 may identify which data elements 114 of metadata 130 of the application 108 would be impacted by the update request 116. In some embodiments, code prompt 126 may include a request to LLM 104 to identify and return the portion(s) of metadata 130 (and/or source code 112) related to or otherwise impacted by update request 116. For example, the new code 106 may include a list of the data elements 114, which CGS 102 may then format into an application snippet 120 for user 110 review/approval.

In 330, the one or more data elements are provided for display via the user interface. For example, CGS 102 may generate an application snippet 120 including the data elements 114 related or that are likely to be impacted by the update request 116.

In 340, new code corresponding to the update is generated. For example, a prompt generator 124 may generate a code prompt 126 to generate new code 106 corresponding to update request 116. The new code 106 may be in the same programming language, or a compatible programming language, as source code 112.

In 350, the new code is provided for display via the user interface. For example, CGS 102 may receive new code 106 from LLM 104. CGS 102 may then format for display, via a chatbot (window) 118 the new code 106 for user review/approval/modification. In some embodiments, CGS 102 may generate a modifiable file with new code 106, such that user 110 may modify (134) the new code 106 in a code preview 132 window. The user 110 may then approve the new code 106.

In 360, the new code, corresponding to the update, is integrated into the application. For example, prompt generator 124 may generate a finalize prompt 142 which may cause LLM 104 to integrate the new code 106 into source code 112. In some embodiments, a first finalize prompt 142 may cause LLM 104 to update a local copy of source code with new code 106, as part of generating simulation 136. Then, for example, upon receiving user approval of the updated local copy of application 108, prompt generator 124 may generate a second finalize prompt 142. The second finalize prompt 142 may instruct LLM to update the source code 112 of a live or active version 144 of application 108, which the user 110 is authorized to update.

In some embodiments, once the live or cloud version of the application 108 has been updated, CGS 102 may send a message to user 110 or the various tenants 146 that the application 108 has been updated with the new functionality in accordance with update request 116. The tenants 146 may then access the application 108 with the updated functionality based on new code 106.

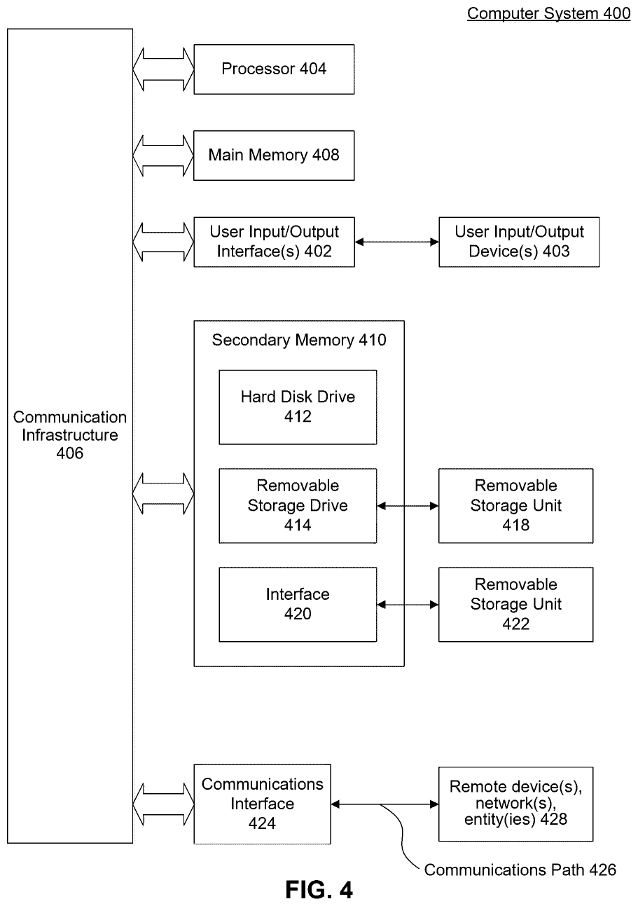

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving, via a user interface, a command to update an application;
retrieving metadata of the application, the metadata comprising one or more data elements associated with the update;
providing the one or more data elements for display via the user interface;
generating, by one or more processors, new code corresponding to the update;
providing the new code for display via the user interface; and
integrating the new code, corresponding to the update, into the application, wherein the application including the update is available to one or more users.

2. The computer-implemented method of claim 1, wherein the generating comprises:
generating a code prompt for a large language model (LLM), wherein the LLM is configured to generate the new code corresponding to the update;
providing the code prompt to the LLM; and
receiving the new code corresponding to the update from the LLM, responsive to the code prompt.

3. The computer-implemented method of claim 2, further comprising:
generating a finalize prompt for the LLM, the finalize prompt comprising a command to integrate the new code into source code of the application;
providing the finalize prompt to the LLM; and
receiving a notification from the LLM after the new code has been integrated into the source code of the application.

4. The computer-implemented method of claim 1, further comprising:
generating test data for testing the new code; and
providing a simulation of the application, including the new code, using the test data.

5. The computer-implemented method of claim 4, wherein the simulation is provided locally for a user.

6. The computer-implemented method of claim 5, further comprising:
receiving approval, from the user, on the simulation; and
wherein the integrating comprises integrating the new code into a cloud version of the application, wherein the cloud version of the application is accessible by a plurality of users.

7. The computer-implemented method of claim 1, wherein the providing the new code for display further comprises:
receiving a modification, from a user, to the new code, wherein the new code, including the modification is integrated into the application.

8. A system comprising:
a memory; and
at least one processor coupled to the memory and configured to perform operations comprising:
receiving, via a user interface, a command to update an application;
retrieving metadata of the application, the metadata comprising one or more data elements associated with the update;
providing the one or more data elements for display via the user interface;
generating, by one or more processors, new code corresponding to the update;
providing the new code for display via the user interface; and
integrating the new code, corresponding to the update, into the application, wherein the application including the update is available to one or more users.

9. The system of claim 8, wherein the generating comprises:
generating a code prompt for a large language model (LLM), wherein the LLM is configured to generate the new code corresponding to the update;
providing the code prompt to the LLM; and
receiving the new code corresponding to the update from the LLM, responsive to the code prompt.

10. The system of claim 9, the operations further comprising:
generating a finalize prompt for the LLM, the finalize prompt comprising a command to integrate the new code into source code of the application;
providing the finalize prompt to the LLM; and
receiving a notification from the LLM after the new code has been integrated into the source code of the application.

11. The system of claim 8, the operations further comprising:
generating test data for testing the new code; and
providing a simulation of the application, including the new code, using the test data.

12. The system of claim 11, wherein the simulation is provided locally for a user.

13. The system of claim 12, the operations further comprising:
receiving approval, from the user, on the simulation; and
wherein the integrating comprises integrating the new code into a cloud version of the application, wherein the cloud version of the application is accessible by a plurality of users.

14. The system of claim 8, wherein the providing the new code for display further comprises:
receiving a modification, from a user, to the new code, wherein the new code, including the modification is integrated into the application.

15. A non-transitory computer-readable medium having instructions stored thereon that, when executed by at least one computing device, cause the at least one computing device to perform operations comprising:
receiving, via a user interface, a command to update an application;
retrieving metadata of the application, the metadata comprising one or more data elements associated with the update;
providing the one or more data elements for display via the user interface;
generating, by one or more processors, new code corresponding to the update;
providing the new code for display via the user interface; and
integrating the new code, corresponding to the update, into the application, wherein the application including the update is available to one or more users.

16. The non-transitory computer-readable medium of claim 15, wherein the generating comprises:
generating a code prompt for a large language model (LLM), wherein the LLM is configured to generate the new code corresponding to the update;
providing the code prompt to the LLM; and
receiving the new code corresponding to the update from the LLM, responsive to the code prompt.

17. The non-transitory computer-readable medium of claim 15, the operations further comprising:
generating a finalize prompt for the LLM, the finalize prompt comprising a command to integrate the new code into source code of the application;
providing the finalize prompt to the LLM; and
receiving a notification from the LLM after the new code has been integrated into the source code of the application.

18. The non-transitory computer-readable medium of claim 15, the operations further comprising:
generating test data for testing the new code; and
providing a simulation of the application, including the new code, using the test data.

19. The non-transitory computer-readable medium of claim 18, wherein the simulation is provided locally for a user.

20. The non-transitory computer-readable medium of claim 19, the operations further comprising:
receiving approval, from the user, on the simulation; and
wherein the integrating comprises integrating the new code into a cloud version of the application, wherein the cloud version of the application is accessible by a plurality of users.
